(19) United States
(12) Patent Application Publication
(10) Pub. No.: US 2004/0044967 A1
(43) Pub. Date: Mar. 4, 2004

(54) Semiconductor intellectual property transmission system

(75) Inventors: Ryosuke Okuda, Tokyo (JP); Kikuo Muramatsu, Tokyo (JP)

Correspondence Address: BURNS, DOANE, SWECKER & MATHIS, L.L.P., P.O. Box 1404, Alexandria, VA, 22313-1404, US

(73) Assignee: Mitsubishi Denki Kabushiki Kaisha

(21) Appl. No.: 10/387,490

(22) Filed: Mar. 14, 2003

(30) Foreign Application Priority Data
Aug. 29, 2002 (JP) 2002-251516

(51) Int. Cl. G06F 17/50

(52) U.S. Cl. 716/1

(57) ABSTRACT

When a user makes the user's client computer (8) establish connection with a semiconductor intellectual property transmission service providing unit (3) by way of the Internet and then inputs desired change specifications, a semiconductor intellectual property transmission service providing unit (3) furnishes the change specifications input by the user to a semiconductor intellectual property automatically-changing unit (5). A semiconductor intellectual property data transmission unit (7) then transmits design data on changed semiconductor intellectual property output from the semiconductor intellectual property automatically-changing unit (5) to the user's client computer (8) by way of an internet communication unit (2) and the Internet.

### BACKGROUND OF THE INVENTION

1. Field of the Invention

The present invention relates to a semiconductor intellectual property transmission system for and a semiconductor intellectual property transmission method of transmitting IP (Intellectual Property) that is data on the design of circuits built into semiconductor integrated circuitry by way of the Internet.

2. Description of Related Art

Circuits such as a CPU (Central Processing Unit), a DSP (Digital Signal Processor), a USB (Universal Serial Bus), and an Ethernet (registered trademark) I/F are frequently built into semiconductor integrated circuitry, and have high reusability. They are called IP (Intellectual Property) components and are traded in units as commodity products. In general, when dealing in IP, i.e., semiconductor intellectual property, a supplier hands over design data on the semiconductor intellectual property to a user and charges the user a lump sum for it or charges the user some money corresponding to the frequency of use of the semiconductor intellectual property.

When using the semiconductor intellectual property, the user may desire to partially change the original circuitry. For example, when the original semiconductor intellectual property in which peripheral circuits such as a CPU and a UART (universal asynchronous receiver/transmitter) are disposed has a 4-channel timer, the user has to change the design of the timer so that the number of channels is increased when a 6-channel timer is needed. Although the user need not necessarily change the semiconductor intellectual property when a 2-channel timer is simply needed, the user occasionally needs to change the semiconductor intellectual property for the purpose of reducing the circuit scale and cost of the semiconductor circuitry.

When there is a necessity for changing the semiconductor intellectual property, the user can change it by himself or herself. In most cases, the user makes a request of the semiconductor intellectual property supplier for a change in the semiconductor intellectual property. When the user makes a request of the semiconductor intellectual property supplier for a change in the semiconductor intellectual property, the user pays for the change. On the other hand, when it can be expected that the semiconductor intellectual property will be changed, the semiconductor intellectual property supplier supplies an automatically-changing program for changing a predetermined range of the semiconductor intellectual property to the user as well as the original semiconductor intellectual property. For example, ARC International sells semiconductor intellectual property associated with processors to users and also distributes a program to users, the program enabling users to input change specifications and outputting semiconductor intellectual property changed according to the change specifications.

In accordance with an electronic commerce method of dealing in semiconductor intellectual property, as disclosed in Japanese patent application publication (TOKKAI) No. 2001-312611, a mediator system receives a request for customizing semiconductor intellectual property from a user, customizes the data on the semiconductor intellectual property that the user purchased, and transmits the customized semiconductor intellectual property data to the user. In accordance with this method, the mediator system is placed between the user and the semiconductor intellectual property supplier, and provides an evaluation report showing an evaluation of the quality of the semiconductor intellectual property for the user. In other words, the above-mentioned method is not a method of directly evaluating the semiconductor intellectual property that the user is going to purchase.

Conventionally, methods of reacting a change of the specifications of the semiconductor intellectual property include a method of making a request of the semiconductor intellectual property supplier for a change in the semiconductor intellectual property when the semiconductor intellectual property needs to be changed and a method of distributing an automatically-changing program when supplying the semiconductor intellectual property to the user, as mentioned above. In the method of making a request of the semiconductor intellectual property supplier for a change in the semiconductor intellectual property, a problem is that the user has to exchange change specifications and changed semiconductor intellectual property with the supplier and it takes much time for the user to do so. However, because change specifications are transmitted to the supplier, the method offers an advantage of being able to collect information about the use of the semiconductor intellectual property and to charge for a request for a change in the semiconductor intellectual property. On the other hand, in accordance with the method of distributing an automatically-changing program when supplying the semiconductor intellectual property to the user, while it doesn't take much time for the user to exchange change specifications with the supplier, the semiconductor intellectual property supplier cannot collect information about the use of the semiconductor intellectual property and cannot charge for a change in the specifications of the semiconductor intellectual property. A further problem is that when the automatically-changing program is upgraded, a new version of the program must be distributed again to the user, and therefore it takes much time to perform maintenance of the automatically-changing program.

### SUMMARY OF THE INVENTION

The present invention is proposed to solve the above-mentioned problems, and it is therefore an object of the present invention to provide a semiconductor intellectual property transmission system and a semiconductor intellectual property transmission method capable of customizing semiconductor intellectual property by using an automatically-changing program, enabling a supplier that supplies semiconductor intellectual property to users to charge for a change in the semiconductor intellectual property, and collecting information about the use of the semiconductor intellectual property.

It is another object of the present invention to provide a semiconductor intellectual property transmission system and a semiconductor intellectual property transmission method capable of upgrading the automatically-changing program with a high degree of efficiency.

In accordance with an aspect of the present invention, there is provided a semiconductor intellectual property transmission system including a semiconductor intellectual property automatically changing unit for changing semiconductor intellectual property based on specification parameters input from outside the system, and for outputting the changed semiconductor intellectual property; and a semiconductor intellectual property transmission service providing unit for accepting a request for a change in the semiconductor intellectual property from a user system by way of an internet, for sending input specification parameters to the semiconductor intellectual property automatically changing unit, for transmitting the changed semiconductor intellectual property output from the semiconductor intellectual property automatically changing unit to the user system by way of a data transmission unit, and for accepting information used to charge for the request for a change in the semiconductor intellectual property from the user system.

As a result, because users are allowed to customize their semiconductor intellectual property by using the semiconductor intellectual property automatically changing unit, they can save themselves from having to exchange change specifications with the semiconductor intellectual property transmission system, and the semiconductor intellectual property supplier can charge for any change in the semiconductor intellectual property and collect information about the use of the semiconductor intellectual property by users.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a semiconductor intellectual property transmission system according to embodiment 1 of the present invention;

FIG. 2 is an example of a window displayed by a semiconductor intellectual property transmission service providing unit of the semiconductor intellectual property transmission system according to embodiment 1 of the present invention;

FIG. 3 is a block diagram showing the structure of a semiconductor intellectual property transmission system according to embodiment 2 of the present invention;

FIG. 4 is a diagram for explaining communications between a user's client computer and a semiconductor intellectual property transmission system according to embodiment 3 of the present invention when the user purchases data on a change in semiconductor intellectual property; and

FIG. 5 is a block diagram showing the structure of a semiconductor intellectual property transmission system according to embodiment 4 of the present invention.

### DETAILED DESCRIPTION OF THE PREFERRED EMBODIMENTS

The invention will now be described with reference to the accompanying drawings.

Embodiment 1.

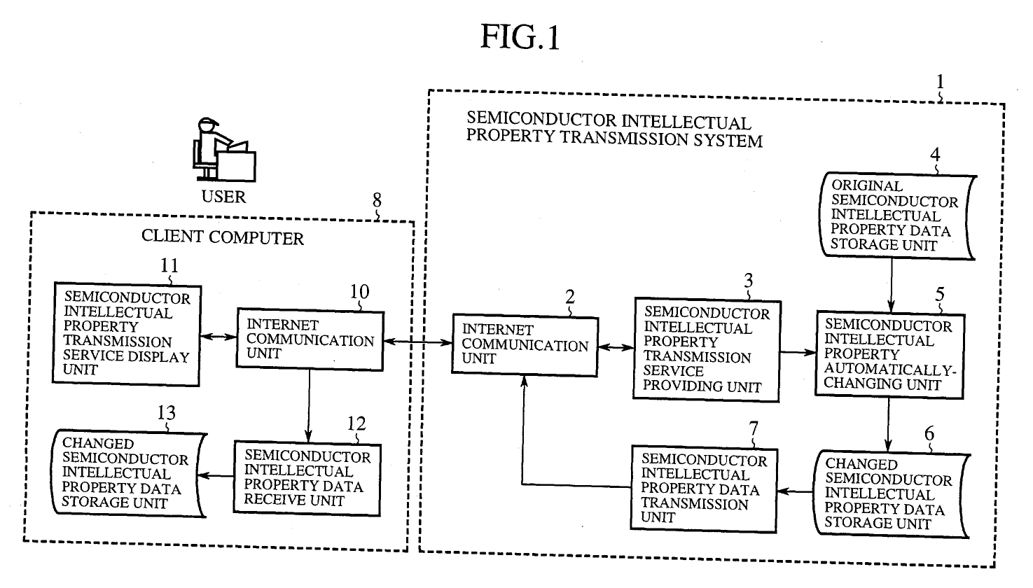

FIG. 1 is a block diagram showing the structure of a semiconductor intellectual property transmission system according to embodiment 1 of the present invention. In the figure, reference numeral 1 denotes the semiconductor intellectual property transmission system, reference numeral 2 denotes an internet communication unit, reference numeral 3 denotes a semiconductor intellectual property transmission service providing unit, reference numeral 4 denotes an original semiconductor intellectual property data storage unit, reference numeral 5 denotes a semiconductor intellectual property automatically-changing unit, reference numeral 6 denotes a changed semiconductor intellectual property data storage unit, and reference numeral 7 denotes a semiconductor intellectual property data transmission unit. The semiconductor intellectual property transmission system 1 is a system disposed on a side of a semiconductor intellectual property supplier, and includes the components 2 to 7. The internet communication unit 2 has a function of connecting the semiconductor intellectual property transmission system 1 with the Internet, and consists of communication hardware components, such as an Ethernet (registered trademark) and a modem, and software components that execute internet protocols. The semiconductor intellectual property transmission service providing unit 3 is a unit for accepting a request for a change in semiconductor intellectual property which is made of the semiconductor intellectual property transmission system 1 by a user by way of the Internet. Typically, the semiconductor intellectual property transmission service providing unit 3 is implemented via software, such as an HTTP (Hyper Text Transfer Protocol) server, and a script written in HTTP language or Java (registered trademark) language. Design data on original semiconductor intellectual property are stored in the original semiconductor intellectual property data storage unit 4. Design data typically include documents such as an RTL (Register Transfer Level) description that is written in HDL (Hardware Description Language), such as Verilog-HDL or VHDL, and that can be logically synthesized, a script in which a condition used for logical synthesis is described, and a reference manual. Furthermore, not only design data on finished products but also design data on half-finished products are included in the design data. The semiconductor intellectual property automatically-changing unit 5 is implemented via a computer program for automatically changing the design data on the semiconductor intellectual property. Semiconductor intellectual property design data (changed semiconductor intellectual property) that are changed automatically by the semiconductor intellectual property automatically-changing unit 5 are stored in the changed semiconductor intellectual property data storage unit 6. The semiconductor intellectual property data transmission unit 7 has a function of transmitting the changed semiconductor intellectual property design data to the user system by way of the Internet by using, for example, an FTP (File Transfer Protocol) server. As an alternative, the semiconductor intellectual property data transmission unit 7 can use a mail system as a transmission mechanism of transmitting the changed semiconductor intellectual property design data to the user side. In this case, the semiconductor intellectual property data transmission unit 7 is a mail sending server.

Reference numeral 8 denotes a client computer that the user uses, reference numeral 10 denotes an internet communication unit, reference numeral 11 denotes a semiconductor intellectual property transmission service display unit, reference numeral 12 denotes a semiconductor intellectual property data receive unit, and reference numeral 13 denotes a changed semiconductor intellectual property data storage unit. The client computer 8 is a personal computer or the like that has the components 10 to 13, and is provided with a display for displaying a screen display produced by the semiconductor intellectual property transmission service display unit 11. The Internet communication unit 10 has the same structure as the Internet communication unit 2. The semiconductor intellectual property transmission service display unit 11 is an interface for exchanging data with the semiconductor intellectual property transmission service providing unit 3, and is normally implemented via software that is called an HTTP browser, for example, the Internet Explorer of Microsoft Corporation. The semiconductor intellectual property data receive unit 12 is a mechanism for communicating with the semiconductor intellectual property data transmission unit 7 so as to receive the changed semiconductor intellectual property design data. In case where the semiconductor intellectual property data transmission unit 7 is an FTP server, for example, when the semiconductor intellectual property data receive unit 12 is an HTTP browser. In case where the semiconductor intellectual property data transmission unit 7 is a mail sending server, a mail browser is used as the semiconductor intellectual property data receive unit 12. The changed semiconductor intellectual property design data received by the semiconductor intellectual property data receive unit 12 are stored in the changed semiconductor intellectual property data storage unit 13.

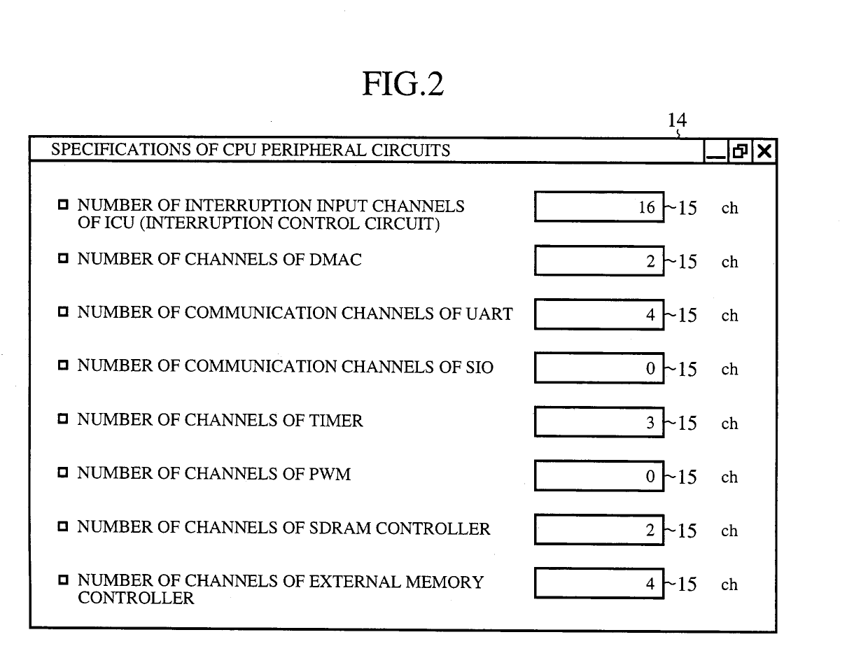

Next, a description will be made as to an operation of the semiconductor intellectual property transmission system according to embodiment 1 of the present invention. The user can operate the client computer 8 to make the Internet communication unit 10 of the client computer 8 establish communications with the internet communication unit 2 of the semiconductor intellectual property transmission system 1 by way of the Internet. The internet communication unit 10 of the client computer 8 simultaneously establishes connection between the semiconductor intellectual property transmission service display unit 11 and the semiconductor intellectual property transmission service providing unit 3. The semiconductor intellectual property transmission service providing unit 3 displays various windows on the display of the client computer 8 by way of the semiconductor intellectual property transmission service display unit 11 so as to urge the user to operate the semiconductor intellectual property transmission system 1. FIG. 2 is an example of a window displayed by the semiconductor intellectual property transmission service providing unit 3. The window 14 is an example via which the user is allowed to input the number of channels for each of peripheral circuits of the CPU, and shows a list of specifications of the semiconductor intellectual property that the user can change. The user can input a desired change in each of the changeable specifications (specification parameters) in each text box 15.

The changed specifications input by the user are transmitted to the semiconductor intellectual property transmission service providing unit 3 by way of the Internet. The semiconductor intellectual property transmission service providing unit 3 delivers the changed specifications input by the user to the semiconductor intellectual property automatically-changing unit 5. The semiconductor intellectual property automatically-changing unit 5 processes the design data on the original semiconductor intellectual property stored in the original semiconductor intellectual property data storage unit 4 based on the received changed specifications so as to generate changed semiconductor intellectual property design data. The generated changed semiconductor intellectual property design data are then stored in the changed semiconductor intellectual property data storage unit 6.

The changed semiconductor intellectual property design data are delivered to the semiconductor intellectual property data transmission unit 7 and are then transmitted to the client computer 8 by way of the Internet. When there is a necessity to prevent the changed semiconductor intellectual property design data from being tapped by third persons, the semiconductor intellectual property transmission system 1 can encrypt the changed semiconductor intellectual property design data before transmitting them. An existing well-known method of encryption can be used for encrypting the changed semiconductor intellectual property design data, and therefore the explanation of the method will be omitted hereafter.

A method of charging for transmission of the changed semiconductor intellectual property data will be explained hereafter. The semiconductor intellectual property transmission service providing unit 3 displays a window via which the user is allowed to input information about the user's credit card and so on (information required for the payment of the changed semiconductor intellectual property data) on the display of the client computer 8 by way of the semiconductor intellectual property transmission service display unit 11. When the client computer 8 establishes connection with the semiconductor intellectual property transmission system 1, the semiconductor intellectual property transmission service providing unit 3 displays the window. As an alternative, when the semiconductor intellectual property transmission system 1 transmits the changed semiconductor intellectual property design data to the client computer 8, the semiconductor intellectual property transmission service providing unit 3 can display the window.

The semiconductor intellectual property transmission system 1 can consist of a plurality of computers other than a single computer. For example, the semiconductor intellectual property transmission system 1 is provided with a computer including the Internet communication unit 2, the semiconductor intellectual property transmission service providing unit 3, and the semiconductor intellectual property data transmission unit 7 and another computer including the original semiconductor intellectual property data storage unit 4, the semiconductor intellectual property automatically-changing unit 5, and the changed semiconductor intellectual property data storage unit 6, which are connected to each other by way of a communication line.

As mentioned above, in accordance with this embodiment 1, the semiconductor intellectual property transmission system 1 disposed on the side of the semiconductor intellectual property supplier has the semiconductor intellectual property automatically-changing unit 5 for automatically changing design data on semiconductor intellectual property changed according to change specifications input by the user and the user is allowed to input desired change specifications by establishing connection between the client computer 8 and the semiconductor intellectual property transmission service providing unit 3 by way of the Internet. As a result, the user is allowed to customize the user's semiconductor intellectual property by using the semiconductor intellectual property automatically-changing program, and the semiconductor intellectual property supplier can collect information about the use of the semiconductor intellectual property by the user.

Furthermore, in accordance with this embodiment 1, the semiconductor intellectual property transmission service providing unit 3 can cause the user to input necessary information required for the payment of the changed semiconductor intellectual property data so that the supplier can charge for the changed semiconductor intellectual property data.

In addition, in accordance with this embodiment 1, because the system on the side of the semiconductor intellectual property supplier has the semiconductor intellectual property automatically-changing unit 5, the semiconductor intellectual property automatically-changing program can be upgraded with a high degree of efficiency.

Embodiment 2.

When selling data on changed semiconductor intellectual property to an individual user, a method of receiving a payment by credit card from the individual user is convenient for collecting a charge for the data. However, when selling data on changed semiconductor intellectual property to such a corporation as a company, such a method is not necessarily convenient for collecting a charge for the data. In accordance with this embodiment 2, a semiconductor intellectual property transmission system has a mechanism for performing authentication of user accounts and provides an available range of semiconductor intellectual property data that can be changed and a method of receiving a payment for each user according to a contract so that when selling data on changed semiconductor intellectual property to such a corporation as a company, the semiconductor intellectual property transmission system can collect a charge for the changed semiconductor intellectual property later based on user account information about the corporation.

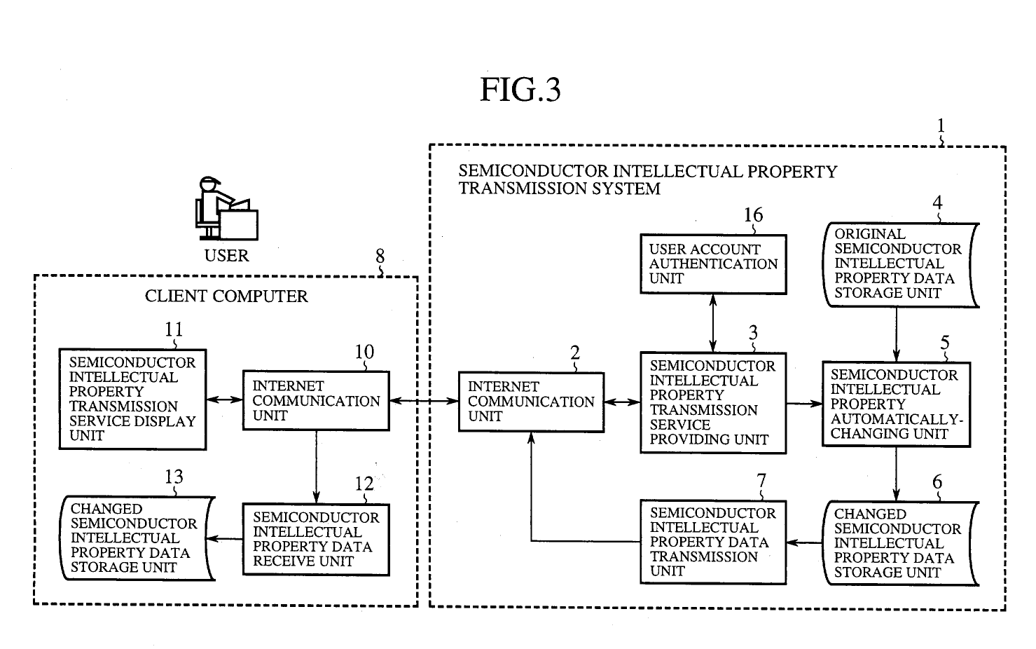

FIG. 3 is a block diagram showing the structure of the semiconductor intellectual property transmission system according to embodiment 2 of the present invention. The same reference numerals as shown in FIG. 1 denote the same components as those of the semiconductor intellectual property transmission system according to embodiment 1. In the figure, reference numeral 16 denotes a user account authentication unit (authentication unit). The user account authentication unit 16 holds information about user accounts and passwords.

When a user makes the user's client computer 8 establish connection with the semiconductor intellectual property transmission service providing unit 3 by way of the Internet, it is requested that the user inputs the user's account and password. The user account authentication unit 16 verifies the input user's account and password against a list of authorized users. When the user changes the design data on the semiconductor intellectual property and purchases the changed semiconductor intellectual property data, the semiconductor intellectual property transmission system 1 collects a charge for the changed semiconductor intellectual property data later based on information about the user's purchase (information accompanied by the user account).

As mentioned above, in accordance with this embodiment 2, the semiconductor intellectual property transmission system 1 can efficiently collect a charge for semiconductor intellectual property data using a user account from such a user as a corporation that repeatedly purchases semiconductor intellectual property.

Embodiment 3.

In general, the user desires to check to see whether semiconductor intellectual property that is changed based on input changed specifications really functions in a desired way and has desired performance before purchasing the data on the changed semiconductor intellectual property. The user further desires to compare evaluations among a plurality of specifications. In accordance with embodiment 3, a semiconductor intellectual property transmission system has two divided steps before the user purchases data on changed semiconductor intellectual property and collects a charge for each of the following two steps.

(1) The semiconductor intellectual property transmission system transmits a part of the design data on the semiconductor intellectual property changed according to change specifications input by the user to the user.

(2) The semiconductor intellectual property transmission system allows the user to evaluate the transmitted data and determine whether to purchase them before ordering them.

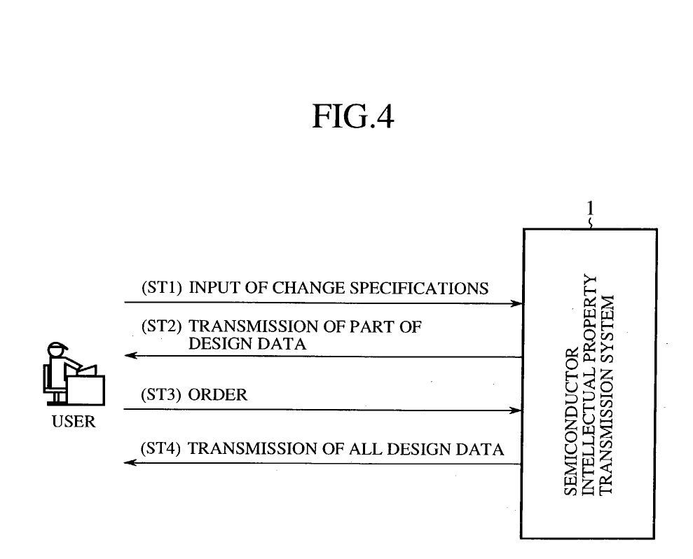

FIG. 4 is a diagram for explaining communications between the user's client computer and the semiconductor intellectual property transmission system according to embodiment 3 of the present invention when the user purchases the data on the changed semiconductor intellectual property. The semiconductor intellectual property transmission system of embodiment 3 and the client computer on the user's side have the same structures as those of embodiment 1 or embodiment 2, respectively. The user can connect with the semiconductor intellectual property transmission system 1 by way of the Internet, and input change specifications, as in the case of embodiment 1 (that is, the user makes a request for acquisition of data required for evaluating the changed semiconductor intellectual property) (in step ST1). The semiconductor intellectual property transmission system 1 changes the design data according to the input specifications by using the semiconductor intellectual property automatically-changing unit 5, and transmits a part of the changed data (data required for evaluating the performance of the changed semiconductor intellectual property) to the client computer 8 on the user's side (in step ST2).

The part of data transmitted to the client computer 8 are data for semiconductor intellectual property evaluation that are not enough for the user to actually manufacture the semiconductor integrated circuitry but are enough for the user to evaluate the changed semiconductor intellectual property. In the case where the semiconductor intellectual property data are written in HDL so that they can be logically synthesized, because transmission of row data written in HDL makes it possible for the user to perform logical synthesis, the semiconductor intellectual property transmission system 1 enables the user to carry out only a simulation of the changed semiconductor intellectual property by transmitting encrypted data written in HDL on the changed semiconductor intellectual property. The user can evaluate whether the changed semiconductor intellectual property has a desired function and desired performance by carrying out a simulation of the changed semiconductor intellectual property.

When the user can ensure that the changed semiconductor intellectual property has a desired function and desired performance, the user orders the design data on the changed semiconductor intellectual property (the user makes a request for purchase of the changed semiconductor intellectual property) (in step ST3). Upon receiving this order, the semiconductor intellectual property transmission system 1 transmits all the design data on the changed semiconductor intellectual property (the entire changed semiconductor intellectual property) to the client computer 8 (in step ST4).

The process for collecting a charge for the changed semiconductor intellectual property in accordance with embodiment 3 will be explained hereafter. The semiconductor intellectual property transmission system 1 collects a charge for the changed semiconductor intellectual property when receiving an order for it. The process for collecting a charge for the changed semiconductor intellectual property can be carried out in the same way as shown in embodiment 1 or embodiment 2. As an alternative, the semiconductor intellectual property transmission system 1 can collect a charge for each of the steps of transmitting data required for the semiconductor intellectual property evaluation and receiving an order for the changed semiconductor intellectual property. In this case, when the user only evaluates the performance of the changed semiconductor intellectual property, he or she only has to pay a small amount of money for the evaluation. The semiconductor intellectual property supplier can collect a proper charge for an evaluation of the changed semiconductor intellectual property and for a purchase of the changed semiconductor intellectual property.

As mentioned above, in accordance with this embodiment 3, because the semiconductor intellectual property transmission system has two divided steps before the user purchases data on changed semiconductor intellectual property so that the user can acquire data required for evaluating the changed semiconductor intellectual property in the first step and can place an order for the changed semiconductor intellectual property in the second step, the user can determine whether to purchase the changed semiconductor intellectual property after checking the performance and functionality of the changed semiconductor intellectual property. In addition, because the semiconductor intellectual property transmission system can collect a charge for each of the two steps, the semiconductor intellectual property supplier can collect a proper charge and the user can get proper value for the charge and therefore the use of the semiconductor intellectual property transmission system is promoted. Embodiment 4.

In embodiment 3, it takes a certain time for the user to evaluate the performance of changed semiconductor intellectual property data before purchasing them. Therefore, during an interval between the step of transmitting data used for enabling the user to evaluate the changed semiconductor intellectual property and the step of receiving an order for the changed semiconductor intellectual property, a breakdown of communications can occur between the client computer and the semiconductor intellectual property transmission system. In the order receiving step, it is inconvenient for the user to input change specifications again and the user may erroneously input them. In contrast, a semiconductor intellectual property transmission system in accordance with embodiment 4 enables the user to place an order by reusing data that they input when receiving data used for enabling the user to evaluate changed semiconductor intellectual property.

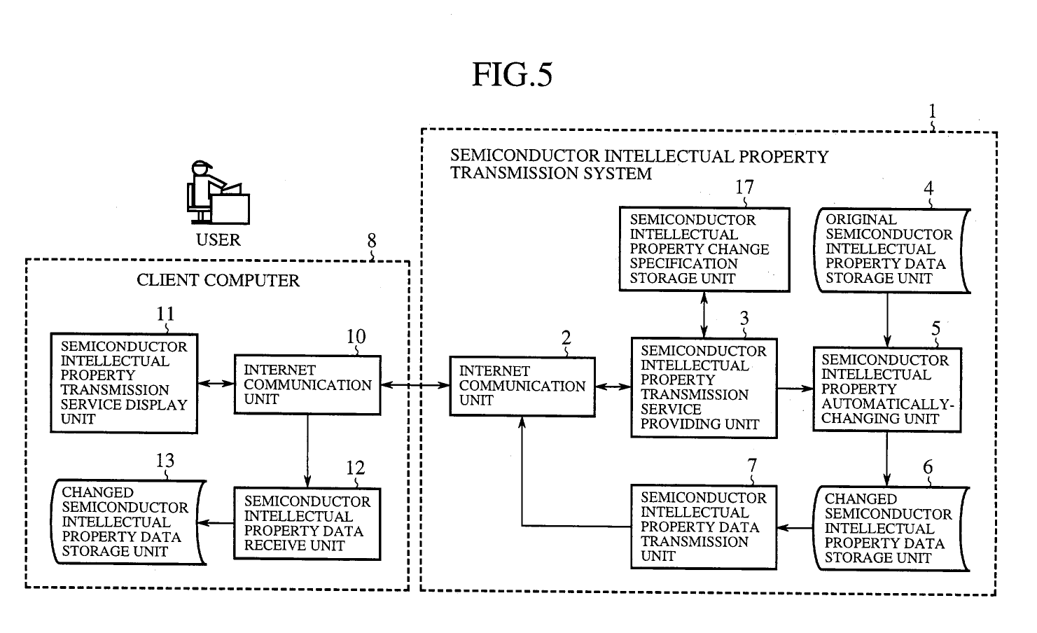

FIG. 5 is a block diagram showing the structure of the semiconductor intellectual property transmission system according to embodiment 4 of the present invention. In the figure, the same reference numerals as shown in FIG. 1 denote the same components as those of the semiconductor intellectual property transmission system of above-mentioned embodiment 1. In FIG. 5, reference numeral 17 denotes a semiconductor intellectual property change specification storage unit for storing change specifications that the user inputs when receiving data used for enabling the user to evaluate changed semiconductor intellectual property.

In operation, when the user inputs change specifications in order to acquire data used for evaluating semiconductor intellectual property changed according to the change specifications, the change specifications are stored in the semiconductor intellectual property change specification storage unit 17. In order for the user to easily refer to the change specifications when placing an order for them later, an identifier can be added to the change specifications. When the user places an order for the changed semiconductor intellectual property, a semiconductor intellectual property transmission service providing unit 3 transmits a list of change specifications stored in the semiconductor intellectual property change specification storage unit 17 to a semiconductor intellectual property transmission service display unit 11 of a client computer 8 by way of the Internet. A semiconductor intellectual property transmission service display unit 11 displays-the list on a display (not shown in FIG. 5). Thus the user can select change specifications that the user desires to order from the list of change specifications.

As mentioned above, in accordance with this embodiment 4, because the semiconductor intellectual property transmission system stores change specifications input by the user in the semiconductor intellectual property change specification storage unit 17 and displays a list of change specifications stored in the semiconductor intellectual property change specification storage unit 17 so that the user can select change specifications from the list when placing an order for changed semiconductor intellectual property, the user can save himself or herself from having to input change specifications again when placing an order for the changed semiconductor intellectual property and therefore the user is prevented from erroneously inputting change specifications.

Many widely different embodiments of the present invention may be constructed without departing from the spirit and scope of the present invention. It should be understood that the present invention is not limited to the specific embodiments described in the specification, except as defined in the appended claims.

What is claimed is:

1. A semiconductor intellectual property transmission system comprising:
a semiconductor intellectual property automatically changing means for changing semiconductor intellectual property based on specification parameters input from outside said system, and for outputting the changed semiconductor intellectual property; and
a semiconductor intellectual property transmission service providing means for accepting a request for a change in the semiconductor intellectual property from a user system by way of an internet, for sending input specification parameters to said semiconductor intellectual property automatically changing means, for transmitting the changed semiconductor intellectual property output from said semiconductor intellectual property automatically changing means to said user system by way of a data transmission means, and for accepting information used to charge for the request for a change in the semiconductor intellectual property from said user system.

2. The semiconductor intellectual property transmission system according to claim 1, further comprising an authentication means for verifying a user account received by way of the internet against a list of authorized user accounts.

3. The semiconductor intellectual property transmission system according to claim 2, wherein when said authentication means verifies that the user account received by way of the internet matches up with an authorized user account, said semiconductor intellectual property transmission service providing means uses information accompanied by the user account, as the information used to charge for a change in the semiconductor intellectual property, instead of accepting the information used to charge for a change in the semiconductor intellectual property from said user system.

4. The semiconductor intellectual property transmission system according to claim 1, wherein when accepting a request for transmission of data on an evaluation of the changed semiconductor intellectual property, said semiconductor intellectual property transmission service providing means transmits only a part of the changed semiconductor intellectual property, which is required for an evaluation of performance of the changed semiconductor intellectual property, to said user system, and, when accepting a request for purchase of the changed semiconductor intellectual property, transmits the entire changed semiconductor intellectual property to said user system.

5. The semiconductor intellectual property transmission system according to claim 4, wherein said semiconductor intellectual property transmission service providing means accepts the information used to charge for a change in the semiconductor intellectual property from said user system when accepting a request for transmission of data on an evaluation of the changed semiconductor intellectual property and when accepting a request for purchase of the changed semiconductor intellectual property.

6. The semiconductor intellectual property transmission system according to claim 4, wherein said semiconductor intellectual property transmission service providing means accepts the information used to charge for a change in the semiconductor intellectual property from said user system only when accepting a request for purchase of the changed semiconductor intellectual property.

7. The semiconductor intellectual property transmission system according to claim 4, further comprising a semiconductor intellectual property change specification storage means for storing the input specification parameters, wherein said semiconductor intellectual property transmission service providing means displays a list of specifications stored in said semiconductor intellectual property change specification storage means and accepts a request for purchase of the semiconductor intellectual property changed according to specifications selected from the list.
